(19) United States
(12) Patent Application Publication
(10) Pub. No.: US 2012/0317088 A1
(43) Pub. Date: Dec. 13, 2012

(54) Associating Search Queries and Entities

(75) Inventors: Patrick Pantel, Bellevue, WA (US); Ariel Damian Fuxman, Mountain View, CA (US)

(73) Assignee: MICROSOFT CORPORATION, Redmond, WA (US)

(21) Appl. No.: 13/154,706

(22) Filed: Jun. 7, 2011

(51) Int. Cl. G06F 17/30

(52) U.S. Cl. 707/706; 707/769; 707/748; 707/E17.108; 707/E17.014

(57) ABSTRACT

The subject disclosure is directed towards processing data to obtain associations between queries and entities. Association is modeled using a query-entity click graph, blending general query-click logs with vertical query-click logs. Smoothing techniques address the data sparsity in such graphs, including interpolation using a query synonymy model. The association models may be applied to the task of recommending products to web queries, by annotating queries with products from a large catalog and then mining query-product associations through web search session analysis.

### BACKGROUND

Commercial search engines use query associations in a variety of ways, including recommending related queries. Mining techniques to extract such query associations generally are based upon clustering queries by their co-clicked URL patterns, leveraging co-occurrences of sequential queries in web search query sessions, pattern-based extraction over lexico-syntactic structures of individual queries and distributional similarity techniques over news or web corpora.

While these techniques work reasonably well to associate queries to one another, suggesting one query based upon another has a somewhat limited application. For example, a user that submits a query to a search engine may want more than just conventional search results and suggested/recommended related queries returned, but a more specific recommendation.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an association model is built that associates queries to entities. Note that queries are short strings. In contrast, entities are distinguished from such strings by various characteristics including that entities have an associated identifier. For example, there may be distinct entities whose textual representations are the same, e.g., in a database of U.S. presidents, there may be two distinct entities (with distinct identifiers) that have the same textual representation “George Bush” corresponding to the 41^{st} and 43^{rd} presidents of the United States. As another characteristic, entities typically reside in a database together with rich structured information. For example, for a digital camera entity, the database may contain its resolution, size, weight, and so forth.

As a result of the association model that associates queries to entities, given a query, entity-related data may be returned, such as a search result, content page, advertisement and/or recommendation corresponding to that entity. Recommendations for a query may be based upon analysis of queries during sessions.

In one aspect, data (e.g., query-entity click data) is processed into the association model. A search engine or the like may then access the association model to return entity-related data in response to a query. For example, the query-entity click data may be processed into a graph that relates queries to entities, with probabilities based upon observed query-entity click counts used to weight edges between query nodes and entity nodes in the graph.

In one aspect, general query-click data (e.g., in query-URL click logs) may be used to infer at least some edges in the graph, e.g., based upon similar click patterns for related queries. Smoothing techniques may be used to determine weights for the inferred edges, e.g., by propagating weight data to the inferred edges based upon the similarity between queries determined from query-URL click patterns, and normalizing the weights for the inferred edges into a background model. The observed click count edge weights may correspond to a foreground model. The association model is built by mathematically combining the foreground model and the background model. For example, linear interpolation may be used, or interpolation in which the interpolation is parameterized by a number of observed clicks may be used.

Query data may also be used to relate one entity to another entity. The entities may be in different knowledge bases, e.g., a product knowledge base and a movie database, a movie database and a news source, and so forth.

In one aspect, a mechanism accesses the association model to use query input to output information corresponding to an entity. The mechanism may be a search engine configured to return a page, a search result, an advertisement and/or a recommendation corresponding to the entity. The mechanism may output information corresponding to one entity that is related to another entity via query data.

Thus, query-entity click data may be processed into a graph in which queries are represented by query nodes and entities are represented by entity nodes. Edges may be determined between at least some of the query nodes and at least some of the entity nodes, in which each edge between a query node and an entity node has an assigned weight computed for that edge. The weight for a given edge may be computed based upon query-entity click data and/or based upon computed relationships between queries. The computed relationships between queries may be determined by processing a query-URL click graph to determine sets (e.g., pairs) of similar queries, and inferring at least some of the edges based upon the sets of similar queries. For example, the weight for each edge based upon the observed query-entity click data may comprise a foreground model that is mathematically combined with a background model corresponding to weights for inferred edges.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components by which models that associate web queries and entities are built offline and used online by search engine.

FIG. 2 is an example representation of a sample graph of node relationships using a query-URL click graph to enhance a query-entity click graph based on similarity relationships between queries found via the query-URL click graph.

FIG. 3A is a example representation of part of the sample click graph showing example similarities between entity nodes and weighted edges from query nodes to entity nodes.

FIG. 3B is an example representation of part of the sample graph showing a weighted edge from query nodes to an entity node based on an observed click count and an inferred edge weighted based upon smoothing.

FIG. 4 is an example representation of a matrix built from session analysis to annotate queries with entity information.

FIG. 5 is an example representation of a temporal sequence of queries in a search session illustrating entity associations propagating from a query-entity click graph to the queries in the session.

FIG. 6 is a block diagram representing an exemplary computing environment into which aspects of the subject matter described herein may be incorporated.

### DETAILED DESCRIPTION

Various aspects of the technology described herein are generally directed towards relating/associating entities (e.g., products, persons and so forth) and/or database records to unstructured textual queries (e.g., Web queries). The resulting associations may be used for enhanced query interpretation, more relevant search and advertising results, and/or alternative search recommendation mechanisms, for example, including recommending related entities for web search queries. Also described is an alternative way to associate entities to other entities or database records.

In general, the technology is based upon understanding the entities implied in query sessions through query analysis, and relationships between entities to queries or to other entities through co-occurring mentions in interpreted query sessions.

It should be understood that any of the examples described herein are non-limiting examples. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and search technology in general.

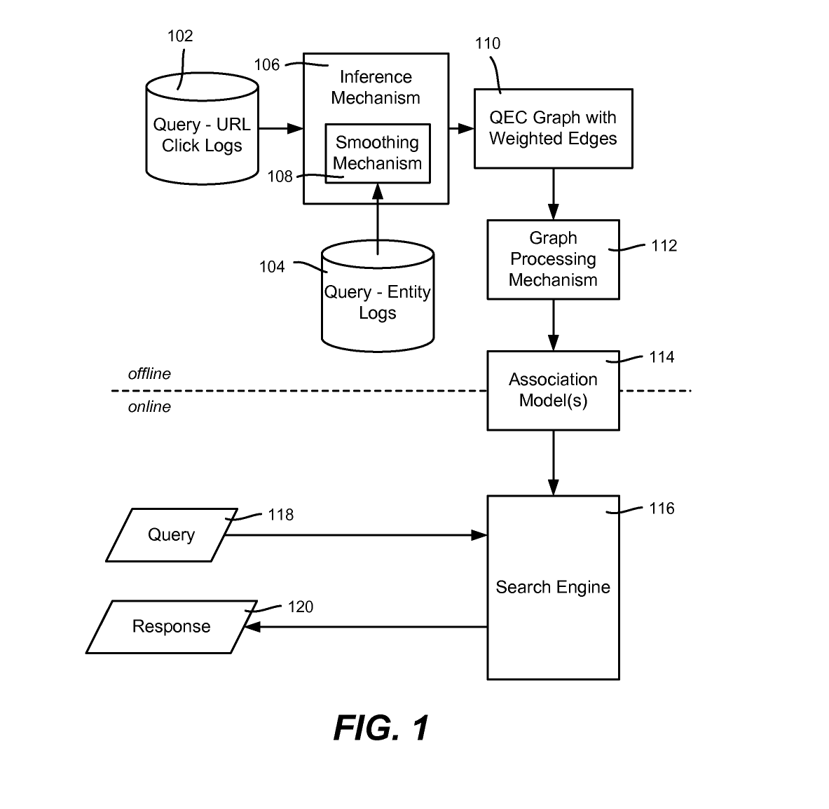

FIG. 1 shows an example of a general system for associating queries and entities. As described herein, query-entity logs 102 for entities like products, people, movies, hotels, travel destinations and so on are collected. For example, when someone enters a query such as “fishing bucket,” some of the search results and/or advertisements may correspond to an entity, that is, a product in this example, and a person may click on that entity. Thus, a click count exists for that particular query and entity.

In one implementation, an expected probability that any arbitrary string refers to each entity in a large database (e.g., a database of products such as Bing™ Commerce, or in a movie database) is computed. Direct data is observable through query-click patterns on the database, via one or more of the query-entity logs 102. If sufficient query-entity data existed, the association may be made from the expected probability.

However, in practice the query-entity data is sparse. To this end, the technology described herein leverages indirect evidence provided by general search query logs 104, including using smoothing techniques, to provide a significantly larger query-entity coverage association graph. Described herein is an inference mechanism 106 (algorithm) that uses query similarity determined from the query-URL click logs to infer missing query-entity probability data, along with the use of smoothing algorithms (via a smoothing mechanism 108), for computing the probability that a query string refers to a database entry/entity even when there is no direct count data for that query-entity.

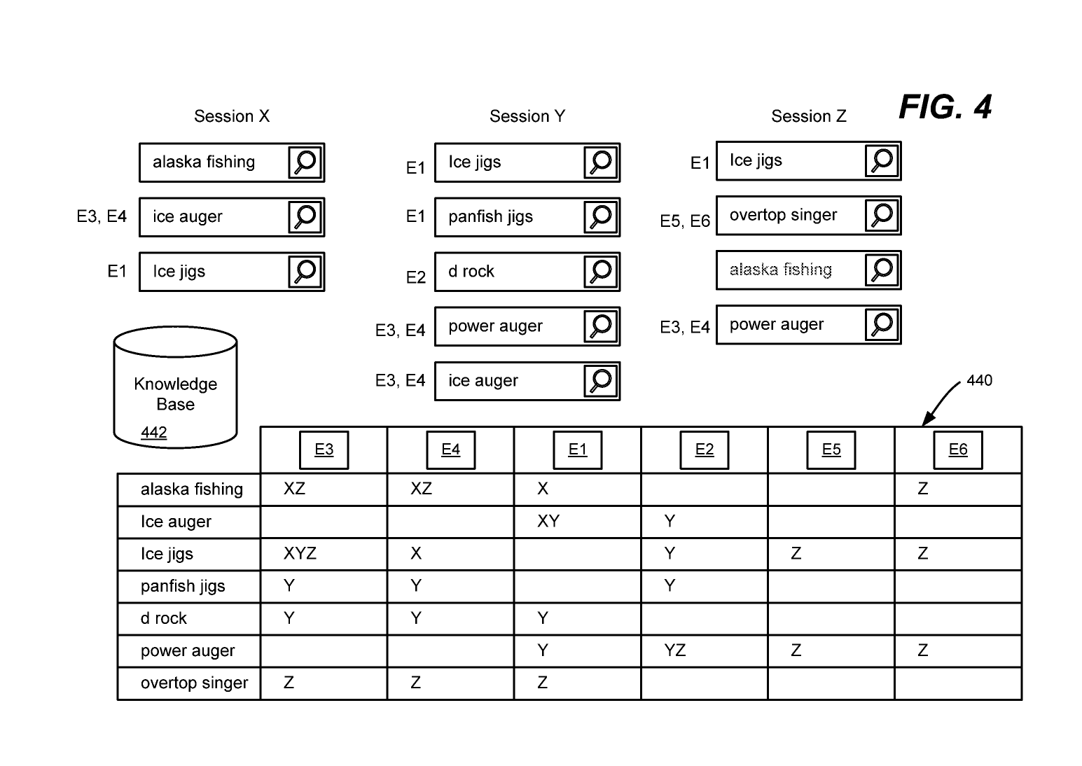

The result may be in the form of a graph 110 with weighted edges (e.g., observed and/or inferred) corresponding to the probabilities. The graph may be used as is as a type of association models, or may be processed (block 112) into one or more association models 114, e.g., for fast access times for online usage. Also, further processing may include session analysis, such as to find entities to recommend for queries, as described below with reference to FIGS. 4 and 5. In online usage, a search engine 116 may use the association model or models 114 when receiving a query 118 to send a response 120 that includes entity-related data (e.g., entity suggestions or search results that link to entity pages).

Clicked results in a vertical search engine comprise edges between queries and entities e in the vertical search engine's knowledge base. Unlike general search engines, vertical search engines have typically much less traffic resulting in extremely sparse click logs relative to conventional search engine logs. Described herein is a graph structure for recording click information and models for estimating P(e|q) using the graph.

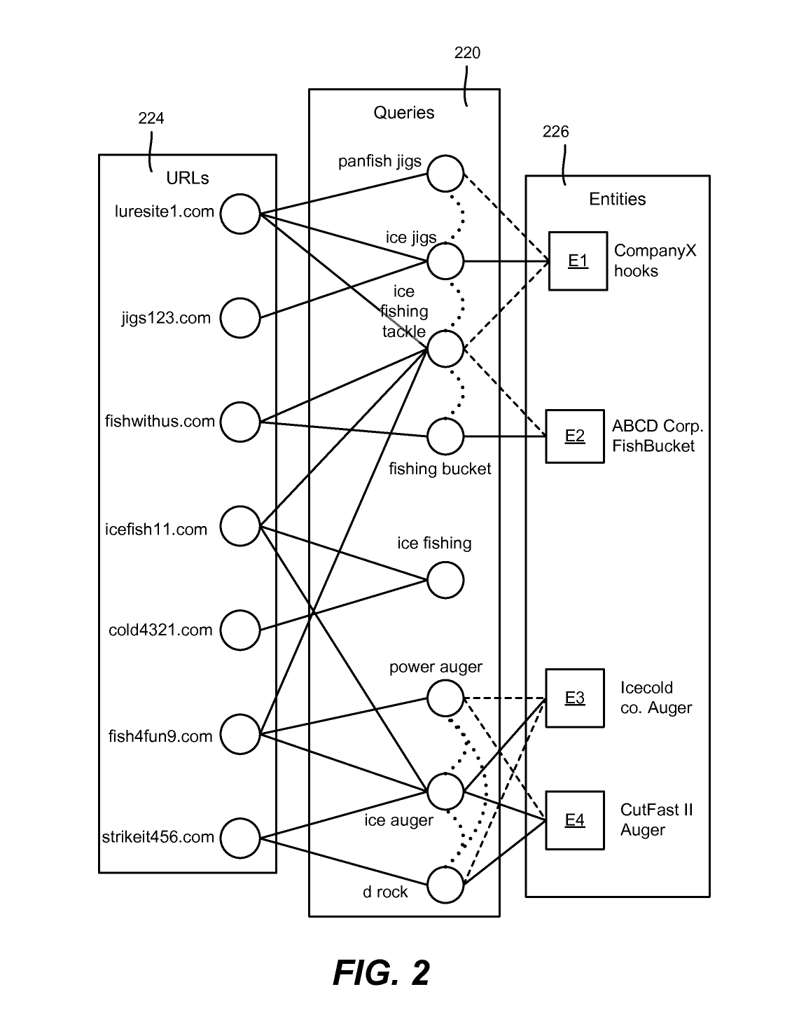

FIG. 2 is an example of a query-entity click (QEC) graph, with queries 222, clicks connecting queries with URLs 224, and clicks to entities 226. As the solid lines between the queries 220 and the entities 226 represent edges with an observed count of one or more clicks, while the dashed straight lines represent inferred edges based upon query-URL similarity. The dotted, curved lines correspond to similarity, as described below.

Thus, the inference mechanism 106 mines query-entity and entity-entity associations from query session logs for estimating the probability that an entity is associated with a web search query. Association is modeled using a query-entity click graph, by blending general query-click logs with vertical query-click logs. Smoothing techniques are described that address the inherent data sparsity in such graphs, including interpolation using a query synonymy model.

More particularly, an association between a query string q and an entity id e is defined herein as the probability that e is relevant given the query q, P(e|q). Relevance may be modeled as the likelihood that a user would click on e given q, events which can be observed in large query-click graphs. Because of the extreme sparsity of contemporary query-click graphs, smoothing models that extend the click graph with query synonyms are also described herein, along with using the synonym click probabilities as a background model.

With respect to the association model, consider a collection of entities, E. Given a search query q, one task is to compute P(e|q), the probability that an entity e is relevant to q, for all e ∈ E. One implementation is constrained to sets of entities that can be accessed through URLs on the web, such as shopping site products, movie databases, reference-site entities, and user-review points of interest sites. Relevance may be modeled as the click probability of an entity given a query, may be observed from click logs of vertical search engines, e.g., domain-specific search engines such as the product search engine at a search site, a shopping/e-commerce site, the local search engine at a user-review site, or the travel search engine at Bing™ travel.

Other contexts such as user search history, social graph and/or geolocation information may be used, (e.g., if a user likes golf entities then golf entities may be relevant to a new query). Such contexts may be leveraged to alter the construction of the QEC graph and/or to modify smoothing methods, including those described herein.

More formally, a query-entity click graph may be defined as QEC(Q ∪ U ∪ E, Cᵤ ∪ Cₑ), as a tripartite graph comprising a set of query nodes Q, URL nodes U, entity nodes E, and weighted edges Cᵤ exclusively between nodes of Q and nodes of U, as well as weighted edges Cₑ exclusively between nodes of Q and nodes of E. Each edge in Cᵤ and Cₑ represents the number of clicks observed between query-URL pairs and query-entity pairs, respectively. The term wᵤ(q, u) represents the click weight of the edges in Cᵤ, and wₑ(_{q,} e) represents the click weight of the edges in Cₑ. If Cₑ is very large, the association probability, P(e|q), may be modeled as the maximum likelihood estimation (MLE) of observing clicks on e given the query q:

$${\hat{P}}_{mle} ( e \vert q ) = \frac{{w}_{e} ( q , e )}{{\sum }_{{e}^{′} ∈ E} {w}_{e} ( q , {e}^{′} )} \qquad ( 1 )$$

As described above, FIG. 2 illustrates an example query-entity graph linking general web queries 220 to entities 226 in a large commercial product catalog, for example. FIG. 2 illustrates eight queries in 220 with their observed clicks (solid lines) with products in entities 228 (there are four such solid lines). Example probability estimates, assigned by Equation (1) above, include:

$${\hat{P}}_{mle} ( panfish jigs , {e}_{1} ) = 0 , {\hat{P}}_{mle} ( ice jigs , {e}_{1} ) = 1$$

$$and$$

$${\hat{P}}_{mle} ( ice auger , {e}_{4} ) = \frac{{c}_{e} ( ice auger , {e}_{4} )}{{c}_{e} ( ice auger , {e}_{3} ) + {c}_{e} ( ice auger , {e}_{4} )} .$$

Even for the largest search engines, query click logs are extremely sparse at present, and smoothing techniques are used. It is even more sparse when considering only Cₑ, those clicked URLs that map to the entity collection E. The sparsity of the graph comes in two forms, namely that there are many queries for which an entity is relevant that will never be seen in the click logs (e.g., “panfish jig” in FIG. 2) and that the query-click distribution is Zipfian in nature and most observed edges will have very low click counts yielding unreliable statistics.

Described herein is expanding QEC with unseen queries that are associated with entities in E, along with smoothing methods for leveraging a background model over the expanded click graph.

The sparsity of edges in Cₑ may be addressed by inferring new edges through traversing the query-URL click subgraph, UC(Q ∪ U, Cᵤ), which contains many more edges than Cₑ. The inferences may be based upon techniques generally described in U.S. published patent application no. 20100318531, assigned to the assignee of the present invention and hereby incorporated by reference. In general, each query is represented by a vector corresponding to its URL clicks (click pattern). If two queries qᵢ and qⱼ are synonyms or near synonyms, then it is expected that their click patterns will be similar; (note that a query qᵢ is a near synonym of a query qⱼ if most relevant results of qᵢ are also relevant to qⱼ). The synonymy similarity, s(qᵢ, qⱼ) may be defined as the cosine of the angle between qᵢ and qⱼ, which are the click pattern vectors of qᵢ and qⱼ, respectively:

$$cosine ( {q}_{i} , {q}_{j} ) = \frac{{q}_{i} \cdot {q}_{j}}{\sqrt{{q}_{i} \cdot {q}_{i}} \cdot \sqrt{{q}_{j} \cdot {q}_{j}}}$$

where q is an nᵤ dimensional vector comprising the pointwise mutual information (pmi) between q and each URL u in U, e.g., pmi(q, u):

$$pmi ( q , u ) = log ( \frac{{w}_{u} ( q , u ) \times {\sum }_{{q}^{′} ∈ Q , {u}^{′} ∈ U} {w}_{u} ( {q}^{′} , {u}^{′} )}{{\sum }_{{u}^{′} ∈ U} {w}_{u} ( q , {u}^{′} ) {\sum }_{{q}^{′} ∈ Q} {w}_{u} ( {q}^{′} , u )} ) \qquad ( 2 )$$

The pointwise mutual information is known to be biased towards infrequent events, and thus a known discounting factor may be applied, e.g., δ(q, u):

$$δ ( q , u ) = \frac{{w}_{u} ( q , u )}{{w}_{u} ( q , u ) + 1} \cdot \frac{min ( {\sum }_{{q}^{′} ∈ Q} {w}_{u} ( {q}^{′} , u ) , {\sum }_{{u}^{′} ∈ U} {w}_{u} ( q , {u}^{′} ) )}{min ( {\sum }_{{q}^{′} ∈ Q} {w}_{u} ( {q}^{′} , u ) , {\sum }_{{u}^{′} ∈ U} {w}_{u} ( q , {u}^{′} ) ) + 1}$$

If two queries are sufficiently similar compared to a threshold similarity, and if one has a query-entity click relationship (a non-zero click count), then a relationship between the other query and the entity may be inferred, (with a probability/weight estimated as described below). More formally, the original QEC graph may be enriched by creating a new edge {q′,e}, where q′∈ Q and e ∈ E, if there exists a query q where s(q, q′)>ρ and wₑ(q, e)>0. The value ρ may be set/tuned experimentally, e.g., setting ρ=0.4 results in a precision >0.9.

Strong similarity also may be used to increase the weight of an existing query-entity edge relationship, e.g., if one query has a high click count to an entity, and the other has a low click count to that entity, yet the queries are very similar, then the low click count may be artificially increased. One way is to discard the actual low click count and using an inferred edge if the inferred probability is higher than the observed (actual) click count-based probability. Another way is to mathematically combine (e.g., interpolate) a foreground model corresponding to the observed click counts and a background model corresponding to inferred click counts, as described below.

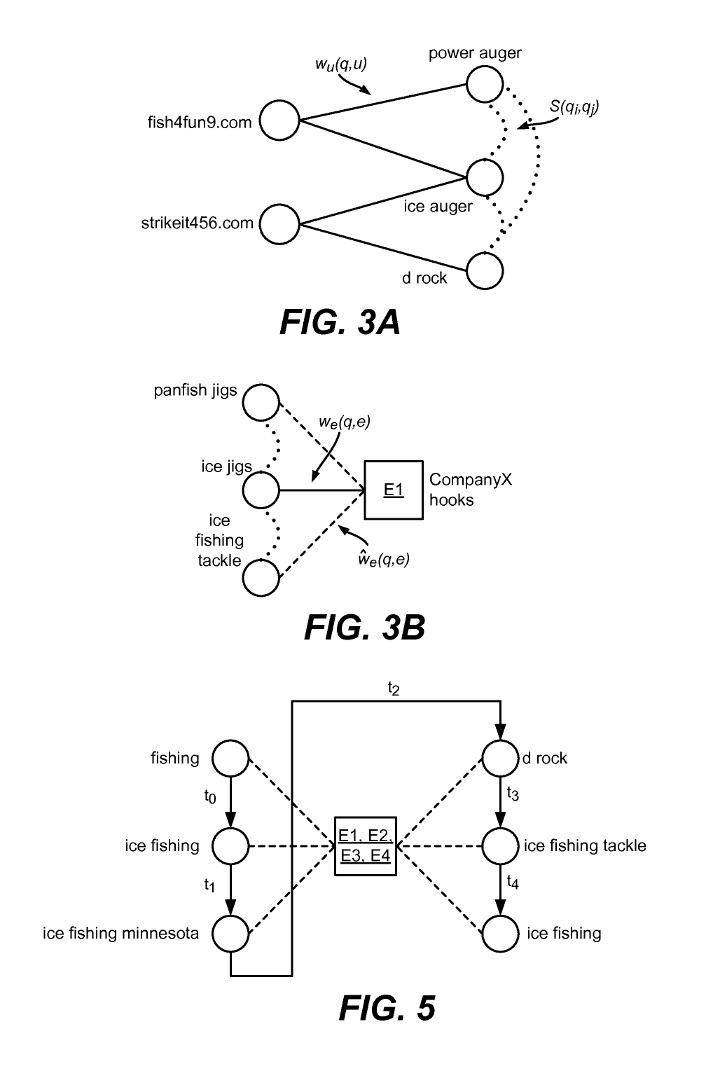

FIG. 3A shows edges in Cu illustrating clicks observed on URLs with weight wᵤ(q, u) as well as synonymy edges between queries with similarity score s(qᵢ, qⱼ). As can be seen, there are similarity edges created between the query “ice auger” and both “power auger” and “d rock”. Because “ice auger” was connected to entities e3 and e4 in the original QEC, one expansion model (FIG. 2) creates new edges in Cₑ between {power auger, e3}, {power auger, e4}, and {d rock, e3}.

For each newly added edge {q, e}, \hat{P}ₘₗₑ=0 according to the model from Equation (1) because there are no observed any clicks between q and e. Instead, a new model is defined that uses \hat{P}ₘₗₑ when clicks are observed, and otherwise assigns uniform probability mass, as:

$${\hat{P}}_{hybr} ( e \vert q ) = \{ \begin{matrix}{\hat{P}}_{pmle} ( e \vert q ) & if ∃ {e}^{′} \vert {w}_{e} ( q , {e}^{′} ) > 0 \\ \frac{1}{{\sum }_{{e}^{′} ∈ E} φ ( q , {e}^{′} )} & otherwise\end{matrix} \qquad ( 3 )$$

where φ(q, e) is an indicator variable equal to one (1) if there is an edge between {q, e} in Cₑ. This implementation of the model does not leverage the local synonymy graph in order to transfer edge weight to unseen edges, however this may be achieved by smoothing.

More particularly, smoothing techniques can be used to alleviate data sparsity problems common in statistical models. In practice, well-known methods that leverage a background model (e.g., a lower-order n-gram model) have worked well. Described herein are example smoothing methods for estimating the target association probability P(e|q).

FIG. 3B highlights two edges, illustrated with dashed lines, inserted into Cₑ during the graph expansion phase described above. In FIG. FIG. 3B for the edges in Ce, the solid lines indicate observed clicks with weight wₑ(q, e) and dotted lines indicate inferred clicks with smoothed weight ŵₑ(q, e). The weight of the background model thus may be represented as ŵₑ(q, e), which can be viewed as smoothed click counts, and is obtained by propagating clicks to unseen edges using the synonymy model as follows:

$${\hat{w}}_{e} ( q , e ) = {\sum }_{{q}^{′} ∈ Q} \frac{s ( q , {q}^{′} )}{{N}_{{s}_{q}}} \times {\hat{P}}_{mle} ( e \vert {q}^{′} ) \qquad ( 4 )$$

where Nₛ_{_{q}}=Σ_{q′∈Q} s(q, q′). By normalizing the smoothed weights, the following background model, \hat{P}_{bsim}, is obtained:

$${\hat{P}}_{b sim} ( e \vert q ) = \frac{{\hat{w}}_{e} ( q , e )}{{\sum }_{{e}^{′} ∈ E} {\hat{w}}_{e} ( q , {e}^{′} )} \qquad ( 5 )$$

Described herein are models for interpolating the foreground model from Equation (1) with the background model from Equation (5). One such model is referred to as a basic interpolation smoothing model, \hat{P}ᵢₙₜᵤe|q), which linearly combines the foreground and background models using a model parametera:

\hat{P}ᵢₙₜᵤ(e|q)=α\hat{P}ₘₗₑ(e|q)+(1−α)\hat{P}_{bsim}(e|q) (6)

Another model is a bucket Interpolation smoothing model. Intuitively, edges {q, e} ∈ Cₑ with higher observed clicks, wₑ(q, e), are to be trusted more than those with low or no clicks. A limitation of \hat{P}ᵢₙₜᵤ(e|q) is that it weighs the foreground and background models in the same way irrespective of the observed foreground clicks. An alternative model, \hat{P}ᵢₙₜₚ(e|q) parameterizes the interpolation by the number of observed clicks:

\hat{P}ᵢₙₜₚ(e|q)=α[wₑ(q, e)]\hat{P}ₘₗₑ(e|q)+(1−α[wₑ(q, e)])\hat{P}_{bsim}(e|q) (7)

In one implementation, the observed click parameter, wₑ(q, e) is bucketed into eleven buckets (1-click, 2-clicks, . . . , 10-clicks, more than 10 clicks}. The α parameters for \hat{P}ᵢₙₜᵤ and \hat{P}ᵢₙₜₚ may be tuned against held-out data. There are twelve parameters that may be tuned, namely a for \hat{P}ᵢₙₜᵤ and α(1), α(2), . . . , α(10), α(>10) for \hat{P}ᵢₙₜₚ, where α(x) is the observed click bucket. For each, the parameter value that minimizes the mean-squared error (MSE) may be chosen; alternatively other optimization criteria such as log-likelihood may be used.

The following table summarizes the association models presented herein as well as the following (used for comparison purposes) model that assigns uniform probability to the edges in QEC:

(8)
${\hat{P}}_{unif} ( e \vert q ) = \frac{1}{{\sum }_{{e}^{′} ∈ E} φ ( q , {e}^{′} )}$

| Label | Model | Reference |
|---|---|---|
| UNIF | \hat{P}_{unif}(e\|q) | Equation (8) |
| MLE | \hat{P}ₘₗₑ(e\|q) | Equation (1) |
| HYBR | \hat{P}_{hybr}(e\|q) | Equation (3) |
| INTU | \hat{P}ᵢₙₜᵣ(e\|q) | Equation (6) |
| INTP | \hat{P}ᵢₙₜₚ(e\|q) | Equation (7) |

Turning to usage of the association models, the association models may be applied to the task of recommending entities to web queries, by annotating queries with entities from a large database and mining query-entity associations through web search session analysis. Also described are commercial applications, e.g., entity recommendations for general web queries using the estimated probability that an entity is associated with a web search query; the models thus may be applied to the task of query-product recommendation.

As generally represented in FIG. 4, queries in session logs are annotated using association probabilities, and recommendations may be obtained by modeling session-level query-product co-occurrences in the annotated sessions. FIG. 5 shows a temporal sequence of queries (t₀-t₄) in a search session illustrating entity associations propagating from a QEC graph to the queries in the session.

In general, during a session, whenever a query has an associated entity, other queries in that same session may have a relationship with that entity. In FIG. 4, “alaska fishing” was a query in the same session X that “ice auger” was a query, and thus there is a relationship between alaska fishing and the entities associated with “ice auger.” These relationships may be used to associate an entity with a query, as described below. Also note that this may help with misspellings, an entity via a query association may be tied back to a misspelled other query by being in the same session.

More particularly, with respect to entity recommendation, after the query-entity associations are mined, where entities are strongly-typed as described above, sessions are annotated with entities that are relevant to the session. For purposes of explanation, a product domain is used as an example, although-it is understood that the models generalize to any entity domain.

For the product example, the universe of entities, E, comprises the entities in a product catalog of a large commercial company for which query-click product clicks Cₑ were observed from the vertical search log of the company. As described above, the QEC graph is completed by extracting query-click-URLs from a search engine's general search logs, Cᵤ.

In general, if an entity is relevant to a query, then it is likely to be relevant to the other queries co-occurring in the same session. One step is query annotation, in which each query q in a session s is annotated with a set E_{q}, comprising every pair {e, \hat{P}_{(e|q)}}, where e ∈ E such that there exists an edge {q, e} ∈ Cₑ with probability \hat{P}_{(e|q)}. Note that E is empty for many queries.

Another step is session analysis, which builds a query-entity frequency co-occurrence matrix 440 (FIG. 4), A, comprising n_{|Q|} rows and n_{|q|} columns, where each row corresponds to a query and each column to an entity. The value of the cell A_{qe} is the sum over each session s, of the maximum edge weight between any query q′ ∈ s and e:

A_{qe}=Σ_{s∈S}ψ(s, e)

where S comprises the observed search sessions and:

$$ψ ( s , e ) = {max}_{\hat{P} ( e \vert {q}^{′} )} ( \{ e , \hat{P} ( e \vert {q}^{′} ) \} ∈ {E}_{{q}^{′}} ) , ∀ {q}^{′} ∈ s$$

Another step is to compute ranking scores between each query q and entity e using pointwise mutual information over the frequencies in A, similarly to Equation (2). The recommendations for a query q are obtained by returning the top-k entities e according to this step. Filters may be applied on: f, the frequency A_{qe}, and p, the pointwise mutual information ranking score between q and e.

Still further, entities may be associated with other entities by way of query relationships. For example, in FIG. 4 the entity E3 (Icecold company's auger product) is related by the “ice auger” query and the “power auger” query to E3 the auger product associated with CutFast II. If sufficient relationships exist, then this association may be used to relate an entity to another, yet indirectly based upon queries rather than users' interaction with entities directly such as collected by shopping sites, e.g., (people who bought product X were also interested in product Y in their knowledge base).

It should be noted that the above processing may be extended across knowledge bases, generally because of relationships via queries. For example, if a query is associated with a movie entity in a movie database (e.g., a movie title), another entity may be associated with that query from a news source, e.g., a news story about an actor in that movie.

As can be seen, described herein is associating web queries (and other surface contexts) with entities, e.g., entities that refer to a particular entry or set of entries in a knowledge base 442 such as a movie database, a product catalog, or The Library of Congress, for example. For example, given a query, the technology described herein is able to recommend specific products from a commercial catalog or set of catalogs.

By knowing strong entity identifiers associated with a query (instead of only strings), the presentation of search results as well as the click-through experience may be improved from the user's perspective. For example, consider when the associated entity is a product. The product name may be presented to the user as a search result or suggestion along with a displayed image, price, and/or reviews associated with the entity identifier. Once the entity is clicked, instead of issuing a simple web search query, the technology is able to directly show a product page for the exact product; actions may be performed directly on the entity, such as buying the entity on a shopping site, retrieving the product's operating manual, polling a social network for friends that own the product, and so forth, thereby providing a richer semantic search experience.

In sum, learning associations between web queries and entities has many possible applications, including query-entity recommendation, personalization by associating entity vectors to users, and direct advertising. This may be accomplished by associating queries to entities by leveraging click graphs from both general search logs and vertical search logs.

### Exemplary Operating Environment

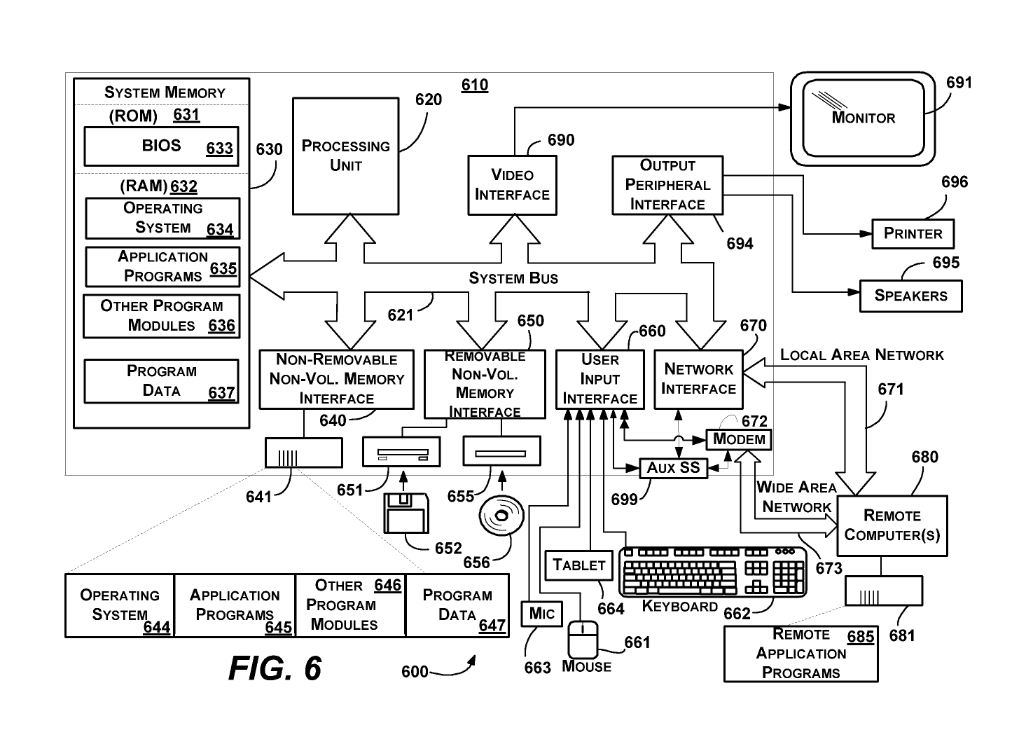

FIG. 6 illustrates an example of a suitable computing and networking environment 600 on which the examples of FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment 600.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 6, an exemplary system for implementing various aspects of the invention may include a general purpose computing device in the form of a computer 610. Components of the computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer-readable media. Computer-readable media can be any available media that can be accessed by the computer 610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636 and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media, described above and illustrated in FIG. 6, provide storage of computer-readable instructions, data structures, program modules and other data for the computer 610. In FIG. 6, for example, hard disk drive 641 is illustrated as storing operating system 644, application programs 645, other program modules 646 and program data 647. Note that these components can either be the same as or different from operating system 634, application programs 635, other program modules 636, and program data 637. Operating system 644, application programs 645, other program modules 646, and program data 647 are given different numbers herein to illustrate that, at a minimum, they are different copies. A user may enter commands and information into the computer 610 through input devices such as a tablet, or electronic digitizer, 664, a microphone 663, a keyboard 662 and pointing device 661, commonly referred to as mouse, trackball or touch pad. Other input devices not shown in FIG. 6 may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. The monitor 691 may also be integrated with a touch-screen panel or the like. Note that the monitor and/or touch screen panel can be physically coupled to a housing in which the computing device 610 is incorporated, such as-in a tablet-type personal computer. In addition, computers such as the computing device 610 may also include other peripheral output devices such as speakers 695 and printer 696, which may be connected through an output peripheral interface 694 or the like.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include one or more local area networks (LAN) 671 and one or more wide area networks (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660 or other appropriate mechanism. A wireless networking component such as comprising an interface and antenna may be coupled through a suitable device such as an access point or peer computer to a WAN or LAN. In a networked environment, program modules depicted relative to the computer 610, or portions thereof, may be stored in the remote memory storage device. By way of example, and not limitation, FIG. 6 illustrates remote application programs 685 as residing on memory device 681. It may be appreciated that the network connections shown are exemplary and other means of establishing a communications link between the computers may be used.

An auxiliary subsystem 699 (e.g., for auxiliary display of content) may be connected via the user interface 660 to allow data such as program content, system status and event notifications to be provided to the user, even if the main portions of the computer system are in a low power state. The auxiliary subsystem 699 may be connected to the modem 672 and/or network interface 670 to allow communication between these systems while the main processing unit 620 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, processing data into one or more association models that associate queries with entities, and using the one or more association models to return entity-related data in response to a query.

2. The method of claim 1 wherein processing the data to associate queries with entities in an association model comprises using query-entity click data to provide a graph that relates queries to entities, computing probabilities based upon observed query-entity click counts, and weighting edges between query nodes and entity nodes based upon the probabilities.

3. The method of claim 1 wherein processing the data to associate queries with entities in an association model comprises using general query-click data to infer at least some edges in a graph that relates queries to entities.

4. The method of claim 1 wherein processing the data to associate queries with entities in an association model comprises using query-entity click data to provide a graph that relates queries to entities, the graph including edges between query nodes and entity nodes that are weighted to represent probabilities based upon observed query-entity click counts, and using general query-URL click data to infer at least some inferred edges between query nodes and entity nodes in the graph based upon similarity between queries determined from query-URL click patterns.

5. The method of claim 4 further comprising, using smoothing to determine weights for the inferred edges.

6. The method of claim 5 wherein using smoothing comprises propagating weight data to the inferred edges based upon the similarity between queries determined from query-URL click patterns, and normalizing the weights for the inferred edges into a background model.

7. The method of claim 6 wherein the edges between query nodes and entity nodes that are weighted to represent probabilities based upon observed query-entity click counts correspond to a foreground model, and wherein processing the data to associate queries with entities in the association model further comprises mathematically combining the foreground model and the background model.

8. The method of claim 7 wherein mathematically combining the foreground model and the background model comprises using linear interpolation.

9. The method of claim 7 wherein mathematically combining the foreground model and the background model comprises using interpolation in which the interpolation is parameterized by a number of observed clicks.

10. The method of claim 1 wherein using the one or more association models to return entity-related data in response to a query comprises returning at least one search result, page or advertisement corresponding to an entity.

11. The method of claim 1 wherein using the one or more association models to return entity-related data in response to a query comprises returning at least one recommendation corresponding to an entity.

12. The method of claim 11 further comprising, determining at least one entity to recommend for a query based upon analysis of queries during sessions.

13. The method of claim 1 further comprising, using query data to relate one entity to another entity.

14. The method of claim 13 wherein the one entity corresponds to one knowledge base and the other entity corresponds to another knowledge base.

15. In a computing environment, a system comprising, an association model that relates queries to entities, and a mechanism configured to access the association model to use query input to output information corresponding to an entity.

16. The system of claim 15 wherein the mechanism comprises a search engine configured to return a page, a search result, an advertisement or a recommendation corresponding to the entity, or any combination of a page, a search result, an advertisement or a recommendation corresponding to the entity.

17. The system of claim 15 wherein the mechanism accesses the association model to output information corresponding to one entity that is related to another entity via query data.

18. One or more computer-readable media having computer-executable instructions, which when executed perform steps, comprising, processing query-entity click data into a graph in which queries are represented by query nodes and entities are represented by entity nodes, determining edges between at least some of the query nodes and at least some of the entity nodes, in which each edge between a query node and an entity node has an assigned weight computed for that edge; and computing the weight for each edge based upon query-entity click data, based upon computed relationships between queries, or both based upon query-entity click data and based upon computed relationships between queries.

19. The one or more computer-readable media of claim 18 having further computer-executable instructions comprising, computing the relationships between queries by processing a query-URL click graph to determine sets of similar queries, and inferring at least some of the edges based upon the sets of similar queries.

20. The one or more computer-readable media of claim 18 wherein computing the weight for each edge based upon the query-entity click data comprises computing a foreground model corresponding to observed query-entity click data, computing a background model corresponding to inferred edges, and mathematically combining the foreground model and the background model.
